(19) United States
(12) Patent Application Publication
(10) Pub. No.: US 2012/0225181 A1
(43) Pub. Date: Sep. 6, 2012

(54) BIRD FOOD FOR DOMESTICATED PETS

(76) Inventor: Randal N. Brue, Saint Cloud, FL (US)

(21) Appl. No.: 13/038,377

(22) Filed: Mar. 1, 2011

(51) Int. Cl. A23K 1/18; A23K 1/00

(52) U.S. Cl. 426/557; 426/630

(57) ABSTRACT

A method of making a packaged food for domesticated birds. The method includes selecting at least one of a plurality of fresh food ingredients having been processed into an easily handled and stable form, the fresh food ingredients selected from vegetables, fruits, berries, pulses, grains and seeds, nuts, and pasta. At least one of a plurality of processed complete food ingredients that contain generally a complete nutritional profile for the domesticated birds is then selected. The selected ingredients are then placed into an aseptic package. The ingredients are then retorted within the aseptic package so that the ingredients within the package have a moisture content between approximately 65% and approximately 78%.

### BACKGROUND

With a plethora of avian foods available to the consumer, pet birds are still at risk of undernourishment due to their owner's failure to provide them with the most nutritious foods. As history has proven, seed-based diets typically fail in providing superior or even adequate nutrition since many of these diets are poorly fortified or designed to deliver proper nutrition. Those that are well designed are only as nutritious as what the bird is willing to consume. Typically, studies have shown that what birds are most likely to consume is typically the nutrient deficient seed portion of the diet.

There are conventional “gourmet” type diets available that offer a wide selection of different food elements and aren't dominated by any single ingredient. These conventional diets offer the best performance of the seed-based diets. However, while significant nutrient deficiencies are not as likely with these diets due to a broader availability and consumption of items, malnutrition still occurs due to selection, preferences and discrimination by the pet against the processed nutrient supplements.

The obvious choice to provide superior nutrition has been to provide a nutrient complete, processed diet. Regrettably only approximately 10% of pet birds are provided this as their primary diet, with a similar amount getting a blend of processed foods and a typical seed diet. Blending these two types of diets can be successful if done to ensure consumption of the processed food, but all too often owners misjudge their bird's actual food intake and oversupply the seed portion. This results in poor consumption of the processed diet as the seed portion is being preferentially consumed by the pet.

Owners typically blame the processed foods poor palatability or “unnaturalness” as the reasons they choose not to use them. At the heart of this is of course the fact that birds typically have to be ‘converted’ to a processed diet, and most owners don't want to subject themselves or their bird to this process.

Therefore, it is desirable to provide pet birds a processed diet that meets these nutritional requirements while being easy to use, readily consumed in its entirety by all birds, and emotionally satisfying to the consumer by consisting of natural, familiar ingredients.

### DESCRIPTION

According to the present disclosure, an improved bird food for domesticated pets may include a combination of a processed, complete food (such as conventional extruded food), and a wide variety of “fresh” ingredients that are provided to the bird in a more readily consumable soft form. As an example, dehydrated carrots are fairly unpalatable to birds in their dry form when used in premium diets. However, in their ‘fresh’ or hydrated cooked form, they are extremely palatable. This is the case for a wide variety of commonly used ingredients. To achieve this, the prepared product is cooked (retorted) to provide a soft texture that birds readily consume. As part of the preparation of the food for packaging, the ingredients may also be pasteurized to reduced bacterial content and improve food safety. In this retorted and pasteurized form, most ingredients become very palatable to birds. This presentation of the ingredients also allows for use of elements in the diet that, in their dry form, are virtually unconsumed, such as pasta.

These products according to the present disclosure address one of the few remaining unmet needs in the pet bird market, specifically a highly palatable, nutritionally complete diet (for the pet) that can be positioned to attract the consumer by appealing to them on a wide variety of meaningful platforms:

Nutrition

Palatability

Convenience

Variety

Freshness

All-natural

Unique, native foods.

Elements of the present disclosure may include but are not limited to the following:
1) Retort technology processing.
2) Aseptic packaging, including, but not limited to:

a) Aluminum can, small serving portion containers;

b) Aluminum foil, small serving portion containers;

c) Plastic, resealable, retort containers;

d) Retortable composite pouch.
3) Single serving portion package sizes of 1.0 to 6.0 ounces or multiple bird portion package sizes of 3.0 to 16.0 ounces.
4) Ingredients may include but are not limited to the following, depending on the product variety:

a) Processed complete food (such as extruded diets) or similarly processed supplemental foods at 5% to 85% of the total dry (pre-cooked) formulation.

b) Fresh, dehydrated, dried or freeze dried fruit at 2% to 50% of the total dry (pre-cooked) formulation. These may include, but are not limited to, apple, grapes, raisins, pears, pomegranate, papaya, mango, pineapple, banana, coconut, orange, cashew fruit and palm fruits.

c) Fresh, dehydrated, dried or freeze dried vegetables at 2% to 50% of the total dry (pre-cooked) formulation. These may include, but are not limited to, corn, carrot, sweet potato, potato, squash, pepper, tomato, zucchini, green beans, green peas.

d) Dried pulses (leguminous crops) at 2% to 50% of the total dry (pre-cooked) formulation.

These may include, but not limited to, lentils, various pea varieties, and various bean varieties.

e) Fresh, dehydrated, dried or freeze dried berries at 2% to 30% of the total dry (pre-cooked) formulation. These may include, but are not limited to, strawberry, blueberry, cranberry, raspberry, currents, mountain ash, juniper, acai (Euterpe oleracea), and goji (Lycium barbarum) berries.

f) Dried whole or processed grains and seeds at 3% to 50% of the total dry (pre-cooked) formulation. These may include, but are not limited to, corn, oats, wheat, barley, buckwheat, rice, millet, canary grass seed, sunflower, safflower, flax, pumpkin, cantaloupe, sesame, and niger seed.

g) Dried whole or processed nuts at 2% to 30% of the total dry (pre-cooked) formulation. These may include, but are not limited to, peanuts, almonds, walnuts, pecans, cashews, filberts, pine nuts, macadamia nuts, and palm nuts.

h) Dried pasta at 2% to 50% of the total dry (pre-cooked) formulation.

i) Various vitamin, mineral and amino acid supplements as needed to balance the dietary nutritional profile based on the contents of the ingredients of a particular formulation and the nutritional requirements of the target bird population.

j) Acidifiers and antioxidants may be included as necessary to assure product stability.

k) Other nutritional supplements include, but are not limited to, Omega-3 fatty acids such as docosahexaenoic acid (DHA), fructooligosaccharides, mannanoligosaccharides, spirulina, yeast cell extracts and carnitine.
5) Moisture content of the finished product may be between 65% and 78%, with a currently preferable target being approximately 72%. Additional experimentation may result in modifications to this range and preferred degree of moisture content.
6) The product contains all nutrients known to be required by pet, exotic birds. The minimum preferred nutrient content, expressed on a dry matter basis, is listed in Table 1 (below). If other nutritional requirements are discovered or derived, it is anticipated that the present disclosure is adaptable to include elements meeting these newly discovered requirements. In addition, it is anticipated that the particular nutrition profile of a bird food product may be adapted for special needs of individual birds. Examples of such requirements may be but are not limited to addressing a need for additional nutrients to promote recovery from illness, building resistance against particular diseases or conditions, promoting plumage growth or color development, etc.

TABLE 1
RECOMMENDED NUTRIENT ALLOWANCES
FOR PET BIRD DIETS*

| | RECOMMENDED |
|---|---|
| | ALLOWANCE |
| | FOR MAINTENANCE |
| NUTRIENT | |
| Protein, % | 12.00 |
| Fat, % | 4.00 |
| Energy, kcal/kg | 3000.00 |
| VITAMINS | |
| Vitamin A, IU/kg | 5000.00 |
| Vitamin D₃_{_{,}} IU/kg | 1000.00 |
| Vitamin E, IU/kg | 20.00 |
| Vitamin K, ppm | 1.00 |
| Thiamine, ppm | 5.00 |
| Riboflavin, ppm | 10.00 |
| Niacin, ppm | 75.00 |
| Pyridoxine, ppm | 10.00 |
| Pantothenic Acid, ppm | 15.00 |
| Biotin, ppm | 0.20 |
| Folic Acid, ppm | 2.00 |
| Vitamin B₁₂_{_{,}} ppb | 10.00 |
| Choline, ppm | 1000.00 |
| Vitamin C | No requirement |
| | demonstrated |
| MINERALS | |
| Calcium, % | 0.50 |
| Phosphorus (available), % | 0.25 |
| Phosphorus (total) approx., % | 0.40 |
| Sodium, % | 0.15 |
| Chlorine, % | 0.15 |
| Potassium, % | 0.40 |
| Magnesium, ppm | 600.00 |
| Manganese, ppm | 75.00 |
| Iron, ppm | 80.00 |
| Zinc, ppm | 50.00 |
| Copper, ppm | 8.00 |
| Iodine, ppm | 0.30 |
| Selenium, ppm | 0.10 |
| AMINO ACIDS | |
| Lysine, % | 0.60 |
| Methionine, % | 0.25 |
| Tryptophan, % | 0.12 |
| Arginine, % | 0.60 |
| Threonine, % | 0.40 |
| Other essential amino acids are | |
| sufficient in common diets. | |

*Source: R. Brue, Adapted from Avian Medicine: Principles and Application, eds. Ritchie, Harrison and Harrison.

It is anticipated that a variety of product styling and packaging combinations may be used within the scope of the present disclosure. Some of these combinations or stylings may include but are not limited to:
Tropical Delight—contains a variety of tropical items that are naturally enticing and nutritious for the bird—papaya, mango, acai berry, cashew fruit, passion fruit, etc. blended with nutrient-rich, softened extruded pieces.
Pasta Crazy—contains a variety of cooked pasta shapes and colors with sun-ripened tomato in a rich tomato flavored sauce along with softened extruded pieces.
Garden Banquet—contains fresh peas, carrots, sweet corn, sweet potato, pepper pieces, sun-ripened tomatoes and beans with softened extruded pieces.
Woodland Feast—contains fresh berries—strawberry, raspberry, acai berry, mountain ash berry, blueberry, currents and grapes—with softened extruded pieces.
Granola Lovers—contains oatmeal flakes, raisins, nut pieces, sunflower, pepitas, millet and softened extruded pieces.
Numerous other combinations.

Beyond these combinations and others within the scope of the present disclosure, it is anticipated that the food will be provided to the consumer in single serving sized packages that may or may not be resealable. The packaging may be suitable for use as a food container for presenting the food to the pet. As such, it is anticipated that a specially adapted holder may be provided which is configured to hold the packaging at a feeding location for the bird so that the food does not need to be transferred from the packaging to a separate food receptacle. Such an arrangement may reduce waste and clean up requirements for the pet owner and allow the living and feeding space for the pet to remain cleaner with less chance for growth of undesirable contaminants.

Instructions provided with the packaging may include instructions for the pet owner to only present the food container to the bird for a limited period of time and then remove the container from the bird's area. Birds will typically eat what they need or desire in a relatively short period of time. Allowing the food to remain in the bird's space beyond that period of time may encourage the bird to play with or spread the food about the living or feeding space. Such activity decreases the cleanliness of the space and increases the maintenance required by the owner. If resealable packaging is used, the uneaten food may be stored in the packaging and possibly presented to the bird again in the next feeding cycle.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A method of making a packaged food for domesticated birds, the method comprising:
selecting at least one of a plurality of fresh food ingredients having been processed into an easily handled and stable form, the fresh food ingredients selected from vegetables, fruits, berries, pulses, grains and seeds, nuts, and pasta;
selecting at least one of a plurality of processed complete food ingredients that contain generally a complete nutritional profile for the domesticated birds;
placing the selected ingredients into an aseptic package;
retorting the ingredients within the aseptic package so that the ingredients within the package have a moisture content between approximately 65% and approximately 78%.

2. The method of claim 1, further comprising selecting at least one of a plurality of dried nutritional supplements desired to be included in the diet for the domesticated birds, placing the selected nutritional supplements into the aseptic package, and retorting the selected nutritional supplements within the aseptic package.

3. The method of claim 1, further comprising pasteurization of the selected ingredients within the aseptic packaging.

4. The method of claim 1, wherein the selected processed complete food ingredients comprise from 5% to 85% of the dry, pre-retorted weight of the ingredients.

5. The method of claim 1, wherein at least one fruit is selected from the processed fresh food ingredients and the selected fruit comprises from 2% to 50% of the pre-retorted weight of the ingredients.

6. The method of claim 1, wherein at least one vegetable is selected from the processed fresh food ingredients and the selected vegetable comprises from 2% to 50% of the pre-retorted weight of the ingredients.

7. The method of claim 1, wherein at least one pulse is selected from the processed fresh food ingredients and the selected pulse comprises from 2% to 50% of the pre-retorted weight of the ingredients.

8. The method of claim 1, wherein at least one berry is selected from the processed fresh food ingredients and the selected berry comprises from 2% to 30% of the pre-retorted weight of the ingredients.

9. The method of claim 1, wherein at least one grain or seed is selected from the processed fresh food ingredients and the selected grain or seed comprises from 3% to 50% of the pre-retorted weight of the ingredients.

10. The method of claim 1, wherein at least one nut is selected from the processed fresh food ingredients and the selected nut comprises from 2% to 30% of the pre-retorted weight of the ingredients.

11. The method of claim 1, wherein at least one pasta is selected from the processed fresh food ingredients and the selected pasta comprises from 2% to 50% of the pre-retorted weight of the ingredients.

12. The method of claim 1, wherein the moisture content within the aseptic package after retort is approximately 72%.
